(19) United States
(12) Patent Application Publication
(10) Pub. No.: US 2013/0127674 A1
(43) Pub. Date: May 23, 2013

(54) ANTENNA WITH COVER RADIATOR AND METHODS

(71) Applicant: Heikki Korva, Tupos (FI)

(72) Inventor: Heikki Korva, Tupos (FI)

(21) Appl. No.: 13/579,559

(22) PCT Filed: Feb. 7, 2011
(86) PCT No.: PCT/FI2011/050102

§ 371 Date: Jan. 11, 2013

(30) Foreign Application Priority Data
Feb. 18, 2010 (FI) 20105158

(51) Int. Cl. H01Q 1/24; H01Q 5/00

(52) U.S. Cl. CPC H01Q 1/241; H01Q 5/0003
USPC 343/702

(57) ABSTRACT

A monopole antenna applicable especially to small mobile stations. The radiator (331) of the antenna is trough-like so that it covers the head surface, front and rear surfaces and both side surfaces of the dielectric cover (310) of the radio device at an end of the device. On the side of the side surfaces there are slots (SL1, SL2) in the radiator starting from its edge for increasing the electric size. The radiator is fed electromagnetically by a separate element (320) which is shaped so that the antenna has at least two operating bands. The ground plane of the antenna is apart from the radiator, thus not extending inside the ‘trough’.

The invention relates to a monopole antenna, the radiator of which follows by shape the outer cover of a device, the antenna being applicable especially to small mobile stations.

In small-sized radio devices, such as mobile phones, the pursuit of space saving is a lasting factor when designing a device. Regarding the antenna, i.a. using a dielectric substrate for the radiator, using a monopole radiator instead of PIFA (Planar Inverted-F Antenna) and the above-mentioned implementation of the radiator in outer cover of the radio device are solutions which save space.

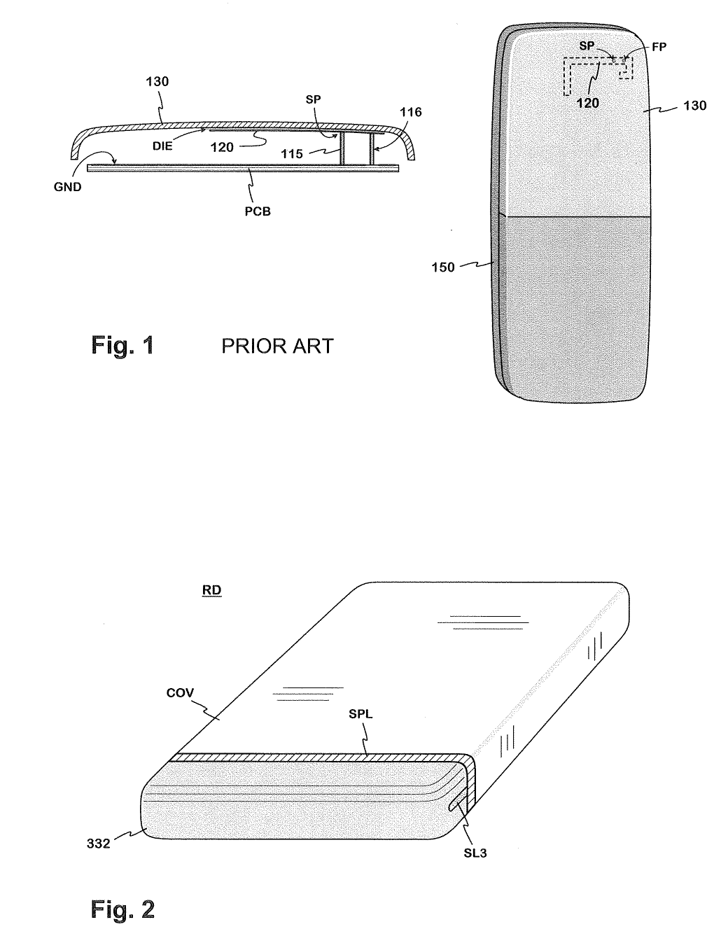

Making the radiator as a part of the device's outer cover is known as such. An example of such an arrangement is the solution for the antenna of a radio device shown in FIG. 1, known from the publication EP 1 439 603. There can be seen a radio device from behind and its cross section at the antenna structure. The upper part 130 of the rear part of the device's outer cover is of conductive material and functions as the radiator of the antenna. The radiator 130 joins the dielectric rest part 150 of the outer cover without discontinuity.

In the cross section figure there is seen the radiator 130 and below it the circuit board PCB of the device, on the upper surface of which board the ground plane GND of the antenna is located. Between the radiator and ground plane there is a conductive feed element 120 which is separated galvanically from the radiator by a distinct thin dielectric layer DIE. The radiator has no galvanic coupling to any conductive part of the radio device. Instead, the feed element 120 is coupled galvanically to the antenna port of the radio device by the feed conductor 116 and to the ground plane by the short-circuit conductor 115. An example of the shape of the feed element 120 is visible in the drawing of the radio device. It is a conductive strip comprising, as viewed from its short-circuit point SP, two arms with different lengths to implement two operating bands for the antenna. The longer arm of the feed element, the radiator 130 and the ground plane GND constitute a resonator, the natural frequency of which is in the lower operating band, and the shorter arm of the feed element, the radiator and the ground plane constitute a resonator, the natural frequency of which is in the higher operating band.

The use of the separate feed element is favourable, because in that case the places of the antenna's operating bands and the matching of the antenna can be arranged without interfering with the shape of the radiator. However, a flaw of the solution in FIG. 1 is that good band characteristics and adequate efficiency require a remarkably long distance between the radiator and the ground plane GND. This again means that the need for antenna space is also in this case greater than desirable.

The object of the invention is to implement an antenna provided with a cover radiator in a new and advantageous way. An antenna according to the invention is characterized by what is set forth in the independent claim 1. Some advantageous embodiments of the invention are disclosed in the other claims.

The basic idea of the invention is as follows: The radiator of an antenna is trough-like so that the head surface, front and rear surfaces and both side surfaces of the dielectric cover of a device are coated by it at an end of the radio device. On the side of the side surfaces there are slots in the radiator starting from its edge for increasing the electric size. The radiator is fed electromagnetically by a separate element which is shaped so that the antenna has at least two operating bands. The ground plane of the antenna is apart from the radiator, thus not extending inside the ‘trough’.

An advantage of the invention is that the radiator of an antenna is short in the longitudinal direction of the radio device, and the space required by the antenna in the radio device is thus relatively small. This is due to the trough-like shape of the radiator and the slots on its sides. Thanks to the slots the radiator, which resonates at a certain frequency, becomes smaller. Also the monopole structure, or the location of the ground plane apart from the radiator, results in a smaller size of the radiator. Another advantage of the invention is that several resonances, which can be tuned separately, are provided for the antenna.

In the following the invention is described in detail. In the description, reference is made to the accompanying drawings in which

FIG. 1 presents an example of the antenna according to the prior art, in which the radiator is a part of the cover structure,

FIG. 2 presents an example of the radio device provided with an antenna according to the invention,

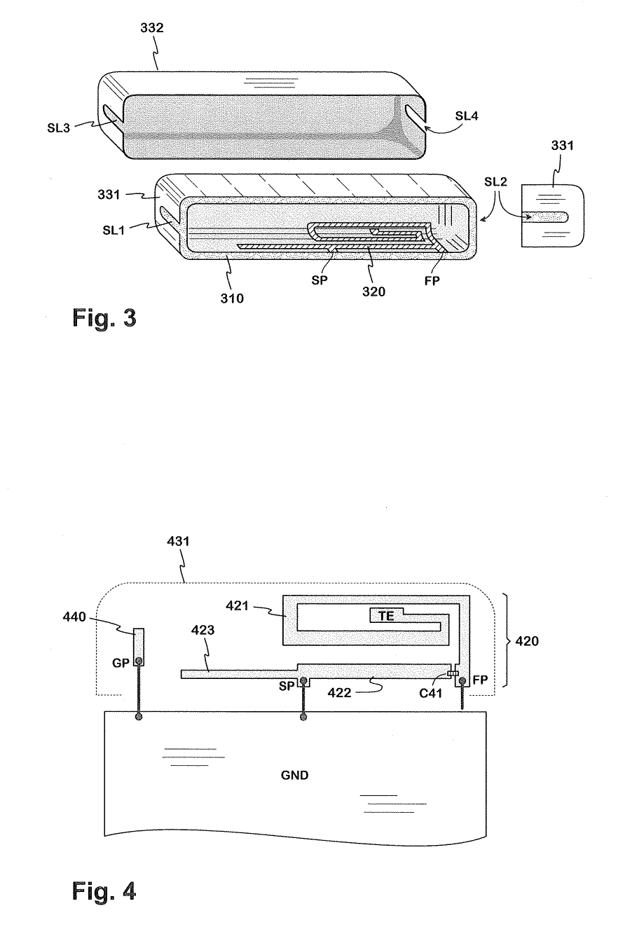

FIG. 3 presents an example of the antenna structure in the radio device according to FIG. 2,

FIG. 4 presents an example of the feed element of an antenna according to the invention,

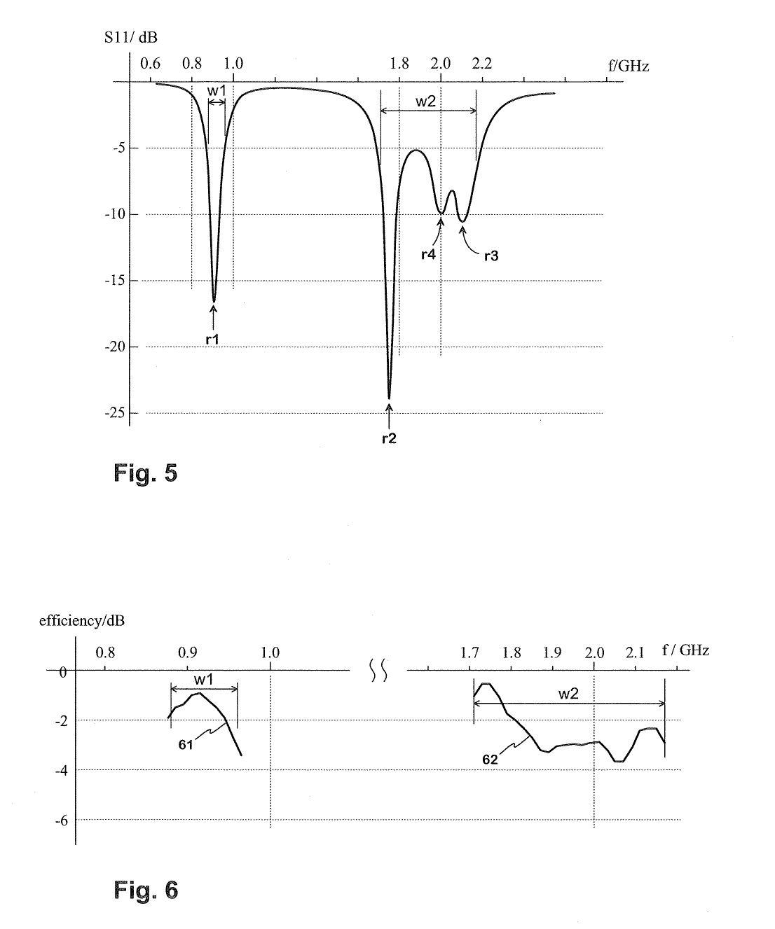

FIG. 5 presents an example of the band characteristics of the antenna according to the invention and

FIG. 6 presents an example of the efficiency of the antenna according to the invention.

FIG. 1 was already described in connection with the description of prior art.

FIG. 2 shows an example of the radio device provided with an antenna according to the invention. The radio device RD is elongated and relatively fiat so that it has two ends, head surfaces corresponding to these ends, front and rear surfaces and first and second side surfaces. The antenna radiator is located at one end of the device which can be the end on the side of the device's speaker or the opposite end. In the figure is seen the outer cover of the device which comprises the main part COV of the cover and the antenna cover 332. In this example, the antenna cover is of conductive material, for which reason it functions as a part of the radiating structure. The radiator proper is underneath it. Also the main part COV of the cover is in this example of conductive material, for which reason there is a relatively narrow non-conductive part SPL of the outer cover between it and the antenna cover 332.

The antenna cover is trough-like by shape, opening naturally towards the middle part of the radio device. A slot, such as the first slot SL3, is on the side of the both side surfaces of the antenna cover, starting from its edge. In the description of FIG. 3 it will be got back to these slots.

FIG. 3 shows an example of the structure according to the invention. The antenna of the radio device presented in FIG. 2 is used as the example. The structure comprises dielectric cover 310, feed element 320, radiator 331 and the above-mentioned antenna cover 332. For the sake of clarity, the antenna cover has been drawn as separate in the figure; in the device it is naturally over the other parts of the antenna structure.

The dielectric cover 310 forms the frame of the end of the radio device and, at the same time, the antenna frame. It is trough-like by shape so that it has a bottom, opposite short sides and opposite long sides. The bottom corresponds to the head surface of the whole device, the short sides correspond to the side surfaces of the whole device at the device's end in question and the long sides correspond to the front and rear surfaces of the whole device at the device's end. On the outer surface of the dielectric cover 310 there is the radiator 331. This has been implemented by metallizing the outer surface e.g. with the LDS method (Laser Directed Structuring). Therefore also the radiator is trough-like following by shape the head surface, the front and rear surfaces and the side surfaces of the radio device. The areas of the outer surface of the dielectric cover starting from the edges of its short sides are left without metallizing so that on the side of the side surfaces of the radio device there are slots being directed from the edge of the radiator towards its bottom. On the side of the first side surface there is the first slot SL1 and on the side of the second side surface there is the second slot SL2. These slots increase the electric size of the radiator. This results in that the resonance, which corresponds to the lowest operating band of the antenna, can be realized by means of a physically smaller radiator compared to a radiator without said slots. The width of the radio device determines the length of the radiator, in which case the decrease in size means the shortening of the radiator in the longitudinal direction of the device, or in the depth direction of the radiator.

On the inner surface of the dielectric cover 310 there is the feed element 320 of the radiator. In the example it extends in the depth direction from the open edge of the dielectric cover to the bottom surface of the cover. The feed element is connected to the transmitter and receiver of the radio device from its certain point FP, which is then the feed point of the antenna. Only an electromagnetic coupling exists between the feed element and the radiator. The feed element is shaped so that it has several resonances together with the radiator and ground plane. The operating bands of the dualband antenna are based on these resonances. An example of this matter is in FIGS. 4 and 5. The feed element is connected also to the ground plane of the antenna from its short-circuit point SP.

In the finished structure the antenna cover 332 is tightly on the radiator, If the antenna cover is of conductive material, as in this example, the slots have to be also in it on the side of the side surfaces of the device to prevent the short-circuit of the slots SL1, SL2 of the radiator. The third slot SL3 in the antenna cover is at above-mentioned first slot SL1, and the fourth slot SL4 is at the second slot SL2. If the device has a steel cover, also the antenna cover is of steel for the sake of appearance. As conductor, steel is clearly poorer than the metal which is used as the radiator 331. For this reason an antenna cover made of steel has little significance as a radiator, although it in principle functions as a part of the radiating structure.

The antenna cover can also be made of a non-conductive material, in which case it lacks the slots SL3 and SL4 seen in FIG. 3.

FIG. 4 shows an example of the feed element of an antenna according to the invention, as spread on a plane. Also the ground plane GND of the antenna is visible in the figure, which ground plane is located beside the feed element and thus also the radiator 431 as viewed in the direction of the normal of the ground plane. The ground plane is parallel with the front and rear surface of the radio device.

In the feed element 420 there are its short-circuit point SP and the feed point FP of the whole antenna, and it includes here three parts. The first part 421 comprises six successive portions which form a simple spiral pattern: the first portion of the first part starts from the feed point FP and is directed away from the ground plane, that is, towards the bottom of the radiator. The second portion is parallel with the edge of the ground plane, or perpendicular to the first portion. The third portion is directed back towards the ground plane, the fourth portion towards the first portion, the fifth portion towards the second portion and the sixth portion towards the third portion. In the tail end TE of the sixth portion there is an extension towards the second portion for strengthening the electromagnetic coupling between said tail end and the second portion.

The second part 422 of the feed element 420 is a mainly straight conductor strip between the ground plane GND and the spiral formed by the first part 421. The second part starts from the feed point FP and ends at the point from which the feed element is connected to the ground plane, or the short-circuit point SP. In the example of FIG. 4 there is a capacitive element C41 between the feed point and the starting end of the second part. By means of the capacitance the antenna matching in the lower operating band is improved so that this band widens a little.

The third part 423 of the feed element is a continuation of the second part from the short-circuit point SP forward. It has the same direction as the second part and is open at its outer end.

The feed element 420 has three significant resonances together with the radiator and ground plane. The lowest frequency resonance, or the first resonance, is based on the electric length of the structure constituted by the first 421 and second 422 part of the feed element and the capacitive element between these parts. The higher frequency resonance, or the second resonance, is based on the electric length of the conductor constituted by the second 422 and third 423 part. It can be tuned by changing the physical length of the third part. The highest frequency resonance, or the third resonance, is a harmonic resonance of the first resonance. It can be tuned by changing said electromagnetic coupling between the second and sixth portions of the first part 421 by shaping the tail end TE of the sixth portion.

Also a tuning element 440 is seen in FIG. 4. It is a conductor strip on the inner surface of the dielectric cover, connected to the ground plane from its one end. By means of the tuning element is affected the resonance which the radiator has alone (naturally with the co-operation of the ground plane), which resonance is then the fourth significant resonance of the antenna to be considered. The tuning element can be located, in respect of the feed element, e.g. on the opposite side of the trough formed by the dielectric cover.

FIG. 5 shows an example of the band characteristics of an antenna according to the invention. The antenna is like the one presented in the previous figures; the capacitance of the matching capacitor C41 between the feed point and second part of the feed element is 4.7 pF. The curve shows the fluctuation of the reflection coefficient S11 of the antenna as the function of frequency. The lower the reflection coefficient, the better the antenna has been matched. The feed element is shaped so that the antenna has two operating bands, the lower and higher one. The lower operating band is based on the above-mentioned first resonance r1, the frequency of which is about 0.9 GHz. It is seen from the curve that the lower operating band covers the frequency range 880-960 MHz (w1 in the figure) used by the EGSM system (Extended GSM), when the value −5 dB of the reflection coefficient is considered to be the criterion of the boundary frequency of the band. The higher operating band is based on the above-mentioned second, third and fourth resonance. The frequency of the second resonance r2 is about 1.75 GHz, the frequency of the third resonance r3 is about 2.1 GHz and the frequency of the fourth resonance r4 is about 2.0 GHz. It is seen from the curve that the higher operating band well covers the frequency range 1710-2170 MHz (w2 in the figure) used by the systems GSM1800, GSM1900 and WCDMA in all. The fourth resonance is tuned between the second and third resonances on the frequency scale, by which means the reflection coefficient can be kept low in the whole large operating band. Without the fourth resonance the antenna matching would be poor in the middle range of the band.

FIG. 6 shows an example of the efficiency of an antenna according to the invention in free space. Curve 61 shows the fluctuation of the efficiency in the lower operating band. in the range w1 the efficiency fluctuates between −1 dB and −3 dB being about −1.6 dB on average. Curve 62 shows the fluctuation of the efficiency in the higher operating band. In the range w2 the efficiency fluctuates between −0.5 dB and −3.7 dB being about −2.4 dB on average. The values of the efficiency are then very good.

An adjustable antenna according to the invention has been described above. In details, its structure can naturally differ from what is presented. The shape of the feed element of the antenna can vary widely. The resonance frequencies of the antenna can be arranged also so that the number of the operating bands is more than two. The feed element can also be located on the surface of a separate thin and flexible dielectric plate which is fastened on the surface of the antenna frame. The antenna frame again can be, besides the same as the dielectric cover of the antenna, also a separate dielectric object to be placed inside the dielectric cover. The tuning element affecting the resonance frequency of the radiator can be located at different places in the antenna structure. The inventive idea can be applied in different ways within the scope set by the independent claim 1.

1.-8. (canceled)

9. An antenna for use in a radio device, comprising:
a feed element having feed and short circuit points associated therewith, at least the short circuit point being in electrical communication with a ground plane of the radio device; and
a device end cover, the end cover comprising a dielectric and having the feed element disposed on an interior surface thereof, and at least one conductive coating on an outer surface thereof, the at least one conductive coating forming at least part of a multiband radiator.

10. The antenna of claim 9, wherein the end cover is substantially tub-shaped and has an interior volume, and the ground plane is disposed so that it does not enter into the interior volume.

11. The antenna of claim 9, wherein the conductive coating comprises a laser-direct structured (LDS) coating.

12. The antenna of claim 9, further comprising a metallic cover element disposed substantially over the end cover, the metallic cover element acting as part of the radiator.

13. The antenna of claim 9, wherein the end cover is substantially rectangular and comprises two end surfaces, and the conductive coating comprises at least one slot formed on each of the two end surfaces.

14. The antenna of claim 13. wherein the antenna comprises a multiband monopole antenna having upper and lower operating bands.

15. The antenna of claim 14, wherein the at least one slots are configured to increase the electric size of the radiator, and to decrease the physical size of the radiator at frequencies within the lower operating band.

16. The antenna of claim 13, wherein the end cover comprises an interior volume, and disposition of the radiator at the end cover of the radio device allows the ground plane to be disposed outside of the interior volume, thereby allowing the device to be thinner than if the feed element were disposed on a front or back cover of the radio device.

17. A mobile wireless device, comprising
a radio transmitter and receiver;
a first device housing element;
a circuit board disposed substantially with the first device cover, the circuit board comprising a ground plane; and
a dielectric device end housing element comprising:
a feed element having a short circuit point in communication with the ground plane, and a feed point coupled to the radio transmitter and receiver; and
a slotted radiator formed on at least part of an exterior of the end housing element;
wherein the feed element, short circuit point, ground plane, and slotted radiator cooperate to provide the wireless device with multiband wireless capability.

18. The mobile wireless device of claim 17, wherein no portion of the ground plane is disposed within the end housing element.

19. The mobile wireless device of claim 17, wherein the end housing element further comprises a substantially metal antenna cover, and the first device housing element is made from a similar metal as the antenna cover, the first element and the end element separated by a dielectric material.

20. A method of operating a wireless antenna, the antenna comprising a feed element with feed point, a short circuit point, a dielectric element, and a radiating element, the method comprising:
feeding a signal to the feed element via the feed point;
short circuiting the feed element to a ground plane via the short circuit point; and
electromagnetically coupling at least portions of the feed element to the radiating element via the dielectric element, the coupling causing the radiator to radiate at least portions of the signal in at least one of an upper band and a lower band in which the antenna is capable of operating.

21. The method of claim 20, wherein the antenna further comprises an at least partly metallic antenna cover disposed over at least a portion of the radiating element, and the method further comprises using the antenna cover as part of the radiating element.

22. The method of claim 21, wherein the radiating element and the antenna cover comprise at least two slots, and the method further includes using the slots to (i) increase the electric size of the radiator, and to (ii) decrease the physical size of the radiator at one or more frequencies within the lower band.

23. An antenna for use in a radio device, the radio device having a head surface and first and second side surfaces, the antenna comprising:
a radiator having an antenna cover associated therewith,
a feed element comprising an electromagnetic coupling to the radiator; and
a ground plane in electrical communication with the radiator;
wherein:
the antenna has at least a lower operating band and a higher operating band;
the radiator is disposed substantially at an end of the radio device, and comprises a conductive coating of a dielectric cover of the radio device, the dielectric cover comprising a trough-like shape so that its bottom corresponds to the head surface of the radio device;
the antenna cover is a part of the dielectric cover; and
the radiator comprises a slot proximate at least one of the side surfaces and starting from an edge of the radiator and to decrease its physical size at the frequencies of the lower operating band of the antenna.

24. An antenna according to claim 23, wherein said feed element comprises:
a feed point configured to be coupled with a transmitter and receiver of the radio device; and
a short-circuit point in communication with the ground plane; and
wherein the feed element has, together with the radiator and ground plane, at least one first resonance on which the antenna's lower operating band is based at least in part, and at least one second resonance on which the antenna's higher operating band is based at least in part.

25. An antenna according to claim 24, wherein the feed element further comprises:
a first part starting from the feed point and forming a substantially spiral pattern;
a second part starting from the feed point and ending at the short-circuit point, the second part being between the first part and the ground plane; and
a third part starting from the short-circuit point and being open at its outer end, the at least one first resonance is further based on the electric length of a structure formed by the first part and the second part of the feed element, and the at least one second resonance is further based on the electric length of a conductor formed by the second part and the third part, and on a harmonic resonance of the at least one first resonance.

26. An antenna according to claim 24, further comprising a capacitive element between the feed point and the starting end of the second part, the capacitive element configured to improve antenna matching in the lower operating band.

27. An antenna according to claim 23, further comprising a tuning element in electrical communication with the ground plane from at least one end thereof and configured to shift a frequency of a resonance which the radiator has with the ground plane, to a desired value.

28. An antenna according to claim 23, wherein the feed element is disposed on the inner surface of said dielectric cover.

29. An antenna according to claim 23, wherein said antenna cover comprises a conductive material, at least a portion of the conductive material forming a part of the radiator.

30. An antenna according to claim 23, wherein said antenna cover comprises a non-conductive material.
